(19) United States
(12) Patent Application Publication
(10) Pub. No.: US 2026/0351735 A1
(43) Pub. Date: Nov. 5, 2026

(54) DISTRIBUTED ZERO-CARBON HYDROGEN NETWORK

(71) Applicants: Allen B. Gruber, Vienna, VA (US); Harry E. Gruber, San Diego, CA (US)

(72) Inventors: Allen B. Gruber, Vienna, VA (US); Harry E. Gruber, San Diego, CA (US)

(21) Appl. No.: 19/486,831

(22) PCT Filed: May 22, 2024
(86) PCT No.: PCT/US2024/030644

§ 371 Date: Nov. 21, 2025

Related U.S. Application Data
(60) Provisional application No. 63/468,520, filed on May 23, 2023.

(51) Int. Cl. H01M 16/00; H01M 8/04082; H01M 8/04858; H01M 8/0656; H01M 10/46

(52) U.S. Cl. CPC H01M 16/006; H01M 8/04201; H01M 8/04932; H01M 8/04947; H01M 8/0656; H01M 10/465; H01M 2220/10; H01M 2250/10

(57) ABSTRACT

A distributed zero-carbon hydrogen network provides for generation, storage, and consumption of zero-carbon hydrogen. The network is scalable, robust, automated, and real-time responsive. The core of the system is movement of zero-carbon hydrogen by various physical means and includes movement of the energy equivalence of zero-carbon hydrogen by conversion of such hydrogen to electricity. The network provides for tracking of transactions, validation of zero-carbon status, and artificial intelligence for overall efficiency of the network and the ability to support production and demand states of hydrogen at different nodes. Hydrogen can be used for, among other things, fueling light, medium and heavy duty vehicles, generation of heat and power, conversion to electricity for electric vehicle charging, lighting, heating and cooling, or other uses of electricity, and as a key component in chemical and industrial processes. The preferred implementation is in a membership program for generators and consumers of zero-carbon hydrogen. The system can also be used by non-members.

### CROSS REFERENCE TO RELATED APPLICATIONS

This application claims the benefit of U.S. Provisional Patent Application 63/468,520, filed May 23, 2023, the disclosures of which are incorporated herein in their entirety for any and all purposes.

### FIELD

This invention relates to a network to produce and distribute zero-carbon hydrogen with production preferably by electrolysis and distribution for various uses. The invention further relates to distribution of hydrogen by physical means and distribution of hydrogen by transporting the energy equivalence of hydrogen.

### BACKGROUND

CO₂ emissions with consequent global warming and climate change are increasingly creating disruptions to everyday living and have ominous implications for the planet. There is worry about melting of the polar ice caps from global warming, CO₂ retention in oceans, increase in the frequency of floods and droughts, reduced crop output and the deleterious health effects of CO₂ on humans and animals. Natural gas in the form of methane for fulfilling energy demands has been a solution to reduce CO₂ emissions as methane releases 50% less CO₂ than coal. The shift away from coal to natural gas and increased use of renewables is still ongoing but these efforts are not felt to be enough to offset the downward spiral of global warming and climate change. Also, methane use is 80 times more harmful than CO₂ in terms of global warming over a 20-year duration due to its long half-life in the ozone layer so there are long term effects of continued use of methane even if this is safer in the short term. There is heightened awareness of the CO₂ issues globally and it now seems desirable to shift to a zero-carbon policy of solar, wind, hydro, nuclear (including small modular reactors, SMR) and geothermal sourced energy; this could include fusion energy, if and when available. The US government, state and local government entities have passed laws and regulations to support these efforts and similar approaches have occurred worldwide, including the Paris Accords.

Transportation related CO₂ emissions contribute to over 40% of total CO₂ emissions. A shift to battery EVs to lower hydrocarbon usage for transportation will depend on energy production with zero-carbon sources. Electrification without shifting to zero-carbon energy sources will not meet our societal objectives. Also, EV batteries require rare earth elements with geopolitical supply chain consequences.

These rare earth elements are costly to mine, are often processed with use of carbon based energy sources, produce air pollution in the final preparation and can have byproducts that are toxic. As examples, grinding graphite is well known to cause air pollution and nickel processing creates toxic waste that must be disposed of. Without a means to store renewable energy other than by batteries, the benefit of EVs will be much less than generally anticipated.

Hydrogen can be both a fuel and an energy source or means of energy storage and has received focus in the US and abroad. Hydrogen, as a fuel, can be a good option for heavy duty vehicles as it creates no CO₂ in its consumption by a fuel cell and carrying hydrogen onboard, as a means of energy storage, is considerably lighter than the batteries needed for electric engines. For long distance travel of light duty vehicles, hydrogen, as a fuel, has the advantage of being refilled by about a 3 to 5-minute process and for heavier duty vehicles hydrogen can be refilled with hydrogen in a matter of minutes versus hours for battery recharging. Hydrogen can be stored for long durations theoretically replacing the needs for large batteries on the electrical grid and functioning as a store of energy from renewables, smoothing out energy fluctuations from using renewable sources. Hydrogen can be used to charge EVs from grid supplied energy or from its onsite generation, storage and consumption. In addition, hydrogen can be used in industrial, commercial and residential applications such as steelmaking, food processing, and heating and cooling, as well in providing electricity from fuel cell generators. While there are carbon utilizing means of producing hydrogen, solar driven electrolysis seems to be gaining ground as a viable option. However, producing enough hydrogen at scale today is mainly performed at centralized facilities from carbon sources such as methane. Also, centralized production leads to CO₂ emissions in transporting hydrogen to the location of use. Carbon capture with sequestration is a means to lower the carbon footprint of methane sourced hydrogen production (i.e. steam methane reforming) but this may create other problems in the future such as CO₂ leakage into the ground water and the process is expensive. Autothermal reforming as an alternative to steam methane reforming may be more efficient but does not lower carbon output enough. Methane pyrolysis can be energy efficient but produces some CO₂ and other carbon byproducts. Zero-carbon hydrogen is hydrogen produced with zero carbon energy sources (renewables such as solar energy and nuclear sources) and therefore does not lead to any CO₂ emissions in its production. What is needed is an efficient means to produce enough zero-carbon hydrogen and to optimize its use and delivery.

### SUMMARY

The disclosure provides a system or network for managing zero-carbon energy production and distribution, wherein the system comprises a zero-carbon hydrogen power grid and an optional electrical power grid; a control server or server subsystem; a plurality of energy consumption and production nodes; one or more hydrogen production systems associated with each node or a subset of nodes; one or more hydrogen storage tanks associated with each node or a subset of nodes; optionally one or more solar collection systems associated with each node or a subset of nodes; optionally one or more electrical storage batteries associated with each node or a subset of nodes; at least one metering system at each node; wherein the control server or server subsystem: receives information about energy data at each of the plurality of nodes, wherein information about energy data is selected from hydrogen levels, tank pressure, battery charge, electrolyzer production criteria, energy consumption data, solar panel array production and any combination thereof; performs a load balancing evaluation based on the received information about energy and hydrogen data, generating node energy information comprising energy excess and energy insufficiency based on results of the load balancing evaluation, sending the generated node energy information to the at least one metering system; and adjusting distribution of hydrogen and/or optional energy equivalence from a high energy node to a low energy node. In on embodiment, the system further comprises providing an energy credit to the high energy node from which energy was distributed to the low energy node by recording the transaction in a real-time accounting system that also records the provenance of the hydrogen produced. In another embodiment, performing the load balancing evaluation includes updating a database comprising energy usage at each node over time to identify peak energy consumption time or energy production time for each node. In still another embodiment, the adjusting distribution of hydrogen and/or energy equivalence comprises pumping or moving hydrogen from a node of high hydrogen content to a node of low hydrogen content. In another embodiment, the adjusting distribution of hydrogen and/or energy equivalence comprises transmission of electrical energy from a node of high energy content to a node of low energy content wherein the transmission of about 33.6 kWh of electricity is the energy equivalence of transmitting 1 kg of Hydrogen or 120 Megajoules of energy. In a further embodiment, a node converts the electrical energy to hydrogen. In still another or further embodiment, excess hydrogen is stored in one or more hydrogen storage tanks or subterranean caverns or geologic formations in a gaseous, liquid, or cryocompressed state, or is absorbed to a liquid organic hydrogen carrier, or absorbed to a metal or a metal hydride or is used to hydrogenate a chemical substance creating methanol, ammonia or other hydrogen containing substances. In a further embodiment, excess hydrogen is converted to electrical energy and the electrical energy stored in electrical storage batteries. In a further embodiment, the electrical energy is converted to hydrogen and the hydrogen stored in hydrogen storage tanks. In another embodiment, the control server or server subsystem provides a user with generated consumer energy data via a graphical user interface accessible by an internet web-browser or mobile application. In still another or further embodiment, of any of the foregoing, the system further comprises real-time availability of energy distribution infrastructure wherein the system functions in an automated fashion, with artificial intelligence, that is responsive to supply and demand using generated and/or stored data. In yet another or further embodiment, each node comprises: one or more compressor(s) or liquefiers, and at least one electrolyzer that produces 5 to 25 kg of hydrogen per week. In another embodiment, hydrogen is stored at low pressure of 300 to 550 bar or high pressure of 600 to 950 bar or as subcooled low pressure liquid hydrogen. In yet another embodiment, hydrogen gas distribution is based on pressure differentials with flow from a hydrogen storage tank comprising high pressure to a lower pressure hydrogen storage tank. In still another embodiment, the energy credit is a zero-carbon credit used for accounting and can be exchanged for legal tender. In another or further embodiment of any of the foregoing, a user member of the system can buy energy directly from sources that use solar, wind, hydro, geothermal energy, zero-carbon battery storage, or nuclear fission or fusion energy and wherein such sources are certified as having a zero-carbon footprint or wherein user members can buy hydrogen in any form from certified zero-carbon sources such as hydrogen from offsite renewable energy driven electrolysis. In another embodiment, the plurality of energy consumption and production nodes are selected from small nodes, medium nodes and large nodes. In a further embodiment, the small node comprises a residential home. In another embodiment, the medium node comprises a retail refueling station. In still another embodiment, the large node comprises a large trucking facility, power producer or commercial generator of hydrogen. In another or further embodiment of the foregoing, the small, medium and/or large node comprises a zero-carbon hydrogen production unit, wherein the zero-carbon hydrogen production unit comprises at least one electrolyzer that produces 5-2000 or more kg of hydrogen per week; at least one buffer tank; at least one compressor or liquefier; and at least one hydrogen storage tank; wherein the at least one electrolyzer is fluidly connected to the at least one buffer tank, which accumulates zero-carbon hydrogen, wherein the at least one buffer tank is fluidly connected to the at least one compressor and/or liquefier, wherein the compressor and/or liquefier is fluidly connected to the at least one hydrogen storage tank and pumps zero-carbon hydrogen into the at least one storage tank to a desired pressure and temperature. In a further embodiment, the at least one compressor is a pneumatic type. In another embodiment, the at least one compressor is a diaphragm or an electrochemical type of compressor. In still another embodiment, the zero-carbon hydrogen is stored at 1-25 bar, 25-50 bar, 50-100 bar, 100-200 bar, 200-300 bar, 350-550 bar and/or 600-1000 bar. In another embodiment, zero-carbon hydrogen is stored in the at least one storage tank in a low-pressure storage tank at a pressure of 300 to 550 bar or a high-pressure storage tank at a pressure of 600 to 1000 bar. In still another embodiment, dispensing zero-carbon hydrogen to a vehicle is based on pressure differentials with flow from the at least one hydrogen storage tank or compressor to a lower pressure and occurs over more than 10 minutes to less than 10 hours. In another or further embodiment of the foregoing, precooling of hydrogen is not utilized, and the at least one electrolyzer, at least one compressor and at least one hydrogen storage tank can fuel one or several vehicles at a time. In another embodiment, a cascade fueling protocol will first use low pressure hydrogen to fill a vehicle to equilibrium and then high-pressure hydrogen to top off the vehicle. In another embodiment, the at least one hydrogen storage tank is fluidly connected to the zero-carbon hydrogen power grid. In yet another embodiment, the system is designed to add additional energy consumption and production nodes to promote network efficiency. In another embodiment, the small node produces 5-25 kg zero-carbon hydrogen per week. In still another embodiment, the medium and large nodes produce 15-2000 or more kg of zero-carbon per week. In a further embodiment, zero-carbon hydrogen is stored at low pressure of less than 10 to 550 bar or high pressure of 600 to 1000 bar. In another embodiment, dispensing of zero-carbon hydrogen to a vehicle occurs over more than 3 minutes but less than 1 hour. In another embodiment of the foregoing, pre-cooling of zero-carbon hydrogen is utilized. In yet another embodiment, the energy credit can be in the form of or representative of kWh or MJ, wherein 1 kilowatt-hour equals 3.6 Megajoules and 33.6 kW-hours equals 120 Megajoules. In another embodiment, the energy equivalence of hydrogen is transported by conversion to electromagnetic energy in the form of radio waves or waves of other frequencies or by means of optical radiation or ultrasound waves. In another embodiment of any of the foregoing, the provenance of zero-carbon hydrogen can be attributed to an energy production source. In still another embodiment of any of the foregoing, the system defines members and access to a zero-carbon hydrogen network, wherein: the member can be a generator of zero-carbon hydrogen; and/or the member can be a consumer of zero-carbon hydrogen. In a further embodiment, membership in the system includes tracking hydrogen generation and storage of carbon-free hydrogen by a member. In a further embodiment, the member can be billed on a monthly or yearly basis or per fueling basis. In another embodiment, a member can be recognized by a credit card with a personal coded identifier or a similar device by a node of the plurality of energy consumption and production nodes on the system. In still another embodiment, the system further comprises maximizing efficient energy conversion and round-trip cost-effectiveness by use of reversible Solid Oxide Electrochemical Cell technology having a stack size of a minimum of 2 KW to generate hydrogen, to convert hydrogen to electricity at the generating site and to receive electricity from the generating site of hydrogen and convert this back into hydrogen and in such manner to transport the energy equivalence of hydrogen. In another embodiment, the system includes transporting hydrogen in a gas or liquid pipeline, designed for hydrogen or otherwise deemed appropriate for hydrogen, between two locations. In still another embodiment, the system comprises transporting hydrogen from one location to another location using a truck, car, van, motorcycle, scooter, bicycle, airplane, boat, ship, train or other vehicle; wherein, the hydrogen is stored in a device suitable for transportation of hydrogen in a compressed or cryocompressed gaseous form or in a liquid form or in a substance where hydrogen is absorbed into a carrier or another molecule (e.g. to form methanol or ammonia). In another embodiment, the system further comprises applying network optimization and artificial intelligence methods, techniques and algorithms or the like, to improve the ability and efficiency of the network or membership to deliver robust, scalable, and reactive performance. In still another embodiment, hydrogen is created with use of solar, wind, hydro, geothermal energy, zero-carbon battery storage, or nuclear, fusion or fission energy. In a further embodiment, hydrogen is created from coupling energy and heat from a nuclear reactor or fusion generator to a Solid Oxide Electrochemical Cell electrolyzer for the maximum efficiency of the overall system.

The disclosure also provides a system of distribution of hydrogen, comprising a hydrogen producer(s) that is not an operator of a utility entity, the hydrogen producer delivering hydrogen into a natural gas line for blending with natural gas to allow offtake at a separate location fluidly connected to the natural gas line, wherein a utility or natural gas line operator facilitates virtual movement of hydrogen and accounting for the amount of hydrogen gas delivered or removed by the hydrogen producer(s) or a consumer. In a further embodiment, the distribution of hydrogen is for any industrial, commercial or residential use selected from the group consisting of fuel for transportation and mobility, heating and cooling, grills, fuel for electricity generation such as in backup generators for homes, data centers for security transactions, military uses, artificial intelligence uses, communications and critical infrastructure systems for buildings and utilities, and applications in steelmaking, food processing and semiconductor manufacture.

### BRIEF DESCRIPTION OF THE FIGURES

Certain embodiments of the invention will now be described by way of examples, wherein

FIG. 1 is a schematic diagram of one embodiment of the network;

FIG. 2 is a block diagram of one embodiment of the flow of hydrogen between the components in a home garage, parking lot, or small-scale node of the network;

FIG. 3 is a block diagram of an embodiment of the components in a home garage node of the network;

FIG. 4 is a block diagram of an embodiment of the components in a parking lot node of the network; and

FIG. 5 is a block diagram of an embodiment of the components in a medium-or large-scale node.

### DETAILED DESCRIPTION

As used herein and in the appended claims, the singular forms “a,” “an,” and “the” include plural referents unless the context clearly dictates otherwise. Thus, for example, reference to “a device” includes a plurality of such devices and reference to “the panel” includes reference to one or more panels, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and systems, the exemplary methods, devices and materials are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Any publications discussed above and throughout the text are provided solely for their disclosure prior to the filing date of the present application. Nothing herein is to be construed as an admission that the inventors are not entitled to antedate such disclosure by virtue of prior disclosure.

As used herein, the term “zero-carbon hydrogen” refers to hydrogen that was produced without relying on any process that generated carbon directly or as a by-product of generating the hydrogen gas. Accordingly, a “zero-carbon hydrogen network” refers to a network of energy distribution that utilizes hydrogen generation nodes that generate zero-carbon hydrogen or hydrogen consuming nodes that use zero-carbon hydrogen. Such zero carbon hydrogen nodes can be linked, monitored and controlled as set forth herein.

The aggregation of distributed hydrogen production from solar based (and from other renewable sources of energy and nuclear or fusion based) electrolysis presents an opportunity to solve the capacity needs and eliminate carbon output but an efficient and trackable system to do so needs to be built or connected to. The disclosure provides such a design to avoid carbon production and is optimized for this purpose.

The disclosure provides for a networked production of zero-carbon hydrogen, particularly by electrolysis using solar energy. The network can control and manage distribution of hydrogen by physical means and by transporting the energy equivalence of hydrogen. In addition, the network includes accounting, providence tracking and tools to support a network along with membership to provide capacity, resiliency, and stability to the energy infrastructure. Real-time availability of the infrastructure where the system functions in an automated fashion and is responsive to supply and demand is also provided.

The disclosure provides a system for managing energy distribution, wherein the system comprises: an electrical and hydrogen power grid; a control server (or subsystem of one or more servers); a plurality of hydrogen production and consumption nodes; one or more hydrogen production systems associated with each of the plurality of hydrogen production and consumption nodes; one or more hydrogen storage tanks associated with each node of the plurality of hydrogen production and consumption nodes; in some instances one or more solar collection systems associated with each node of the plurality of hydrogen production and consumption nodes; in some instances one or more electrical storage batteries (as needed to provide immediate responsiveness and storage of excess energy) associated with each node of the plurality of hydrogen production and consumption nodes; at least one metering system at each node of the plurality of hydrogen production and consumption nodes; wherein the control server (or subsystem of servers) receives information about energy and hydrogen data at each of the plurality of hydrogen production and consumption nodes; performs a load balancing evaluation based on the received information about energy and hydrogen data, generating node information comprising energy excess and energy insufficiency based on results of the load balancing evaluation, and sending the generated energy information to a metering system; adjusting distribution of hydrogen gas (or hydrogen stored in another form such as (a) in a cryogenic liquid, compressed gas, or cyro-compressed supercritical hydrogen state, (b) in a chemical combination such as with a liquid organic carrier, an assortment of metals producing metal hydrides, or sorbent of varous sorts or (c) as a product of a reversible chemical reaction such as in the production of ammonia or methanol) and/or electrical energy from a high energy node to a low energy node in the plurality of hydrogen production and consumption nodes; and providing an energy credit to the high energy node from which energy was distributed to the low energy node. In another embodiment, the step of performing the load balancing evaluation includes updating a database comprising energy usage at each node of the plurality of hydrogen production and consumption nodes over time to identify peak energy consumption time or energy production time for each node of the plurality of hydrogen production and consumption nodes. In another embodiment, the adjusting distribution of hydrogen and/or electrical energy comprises pumping (or moving) hydrogen from a node of high hydrogen content to a node of low hydrogen content. In yet another embodiment, the adjusting distribution of hydrogen gas and/or electrical energy comprises transmission of electrical energy from a node of high electrical energy content to a node of low electrical energy content. In still another embodiment, a node converts the electrical energy to hydrogen gas. In still another or further embodiment of any of the foregoing, excess hydrogen is stored in the one or more hydrogen storage tanks. In still a further embodiment, excess hydrogen is converted to electrical energy and the electrical energy stored in electrical storage batteries or hydroelectric systems. In still other embodiments of the foregoing excess electrical energy is stored in the electrical storage batteries. In a further embodiment, the excess electrical energy is converted to hydrogen and the hydrogen stored in hydrogen storage tanks. In another embodiment, the control server (or subsystem of servers) provides a user with the generated and consumed energy data via a graphical user interface accessible by means of an Internet web-browser. In still further embodiments, the system further comprises real-time availability of energy distribution infrastructure wherein the system functions in an automated fashion, with artificial intelligence, that is responsive to supply and demand using generated and/or stored data. In still further embodiments, of any of the foregoing, each node of the plurality of hydrogen production and consumption nodes comprises: one or more pneumatic driven compressor(s) or a liquefier and an electrolyzer that produces 5 to 25 kg of hydrogen per week. In yet another embodiment, hydrogen is stored at low pressure of 300 to 550 bar or high pressure of 600 to 950 bar or subcooled low pressure liquid hydrogen. In still another embodiment, hydrogen gas distribution is based on pressure differentials with flow from a hydrogen storage tank to a lower pressure hydrogen storage tank and occurs over more than 10 minutes to less than 10 hours in a node of the plurality of hydrogen production and consumption nodes. In still another embodiment, the energy credit is a carbon credit. In still another embodiment, of any of the foregoing embodiments the system provides a further ability of buying energy directly from sources such as solar, wind, hydro, geothermal energy, battery, or nuclear fission or fusion energy wherein members are directed to sources certifying a zero-carbon footprint or buying or using hydrogen in any form from certified zero-carbon sources such as hydrogen from off-site renewable energy driven electrolysis. In any of the prior embodiments of the system of the disclosure, the plurality of energy consumption and production nodes are selected from small sized nodes, medium sized nodes and large sized nodes. In a further embodiment, the small sized node comprises a home. In another embodiment, the medium sized node comprises a retail refueling station or an energy or hydrogen production facility. In still another embodiment, the large sized node comprises a large trucking facility. In another embodiment of any of the foregoing embodiments, the small, medium and/or large sized node comprises a zero-carbon hydrogen production unit, wherein the zero-carbon hydrogen production unit comprises at least an electrolyzer that produces 5-2000 or more kg of hydrogen per week; at least one buffer tank; at least one compressor and/or liquefier; and at least one hydrogen storage tank; wherein the at least one electrolyzer is fluidly connected to at least one buffer tank, which accumulates zero-carbon hydrogen, wherein the at least one buffer tank is fluidly connected to at least one compressor and/or liquefier, wherein the compressor and/or liquefier is fluidly connected to the at least one hydrogen storage tank and pumps zero-carbon hydrogen into the at least one storage tank to a desired pressure and temperature. In a further embodiment, zero-carbon hydrogen is stored in at least one storage tank in a low pressure storage tank at a pressure of 300 to 550 bar or a high pressure storage tank at a pressure of 600 to 1000 bar. In another embodiment, hydrogen is stored at 1-25 bar, 25-50 bar, 50-100 bar, 100-200 bar, 200-300 bar, 350 bar to 550 bar or 600-100 bar (or any value or range between any two of the foregoing values). In still another embodiment, dispensing of zero-carbon hydrogen is based on pressure differentials with flow from the at least one hydrogen storage tank to a lower pressure and occurs over more than 10 minutes to less than 10 hours. In still another or further embodiment, precooling of zero-carbon hydrogen is not utilized, and at least one electrolyzer, at least one compressor and/or liquefier and at least one hydrogen storage tank can fuel one or several vehicles at a time. In another embodiment, a cascade fueling protocol is used wherein a first use is at a low pressure hydrogen to fill a vehicle to equilibrium and then at high-pressure hydrogen to top off the vehicle. In one embodiment, direct fueling from a buffer tank or compressor occurs. In yet another embodiment, at least one hydrogen storage tank is fluidly connected to the zero-carbon hydrogen power grid. In still another embodiment, the system is designed to add additional energy utilization and production nodes to promote network efficiency. In still yet another embodiment, the small node produces 5-25 kg zero-carbon hydrogen per week. In another embodiment, the medium and large nodes produce 15-2000 kg or more of zero-carbon per week. In a further embodiment, zero-carbon hydrogen is stored at low pressure of less than 10 bar or 300 to 550 bar or high pressure of 600 to 1000 bar (or any value between any of the foregoing values). In still another embodiment, dispensing occurs over more than 3 minutes but less than 1 hour. In another embodiment, medium and large nodes utilize precooling of zero-carbon hydrogen. In another embodiment, the energy credit can be in the form of kWh or MJ, wherein 1 kilowatt-hour equals 3.6 Megajoules. In other embodiments of any of the foregoing, energy equivalence of hydrogen is transported by conversion to electromagnetic energy in the form of radio frequency waves or waves of other frequencies or by means of optical radiation or ultrasound sound waves or the like. Since 1 kg of hydrogen has about 33.6 kWh of electrical energy, if 33.6 kWh of electricity were moved from one node to another, then the “energy equivalence” of 1 kg of hydrogen would be moved or translocated from one node to another. In other words, 1 kg of Hydrogen =~33.6 kWh (e.g., 33-34 kWh)=one equivalence unit of Hydrogen. Since 120 megajoules (MJ) of energy, using the lower heat value calculation, is equivalent to 1 kg of Hydrogen, then one unit of equivalence of Hydrogen=120 MJ. In still other embodiments, the systems use network optimization and artificial intelligence methods, techniques and algorithms or the like, to improve the ability of the network or membership to deliver robust, scalable, and reactive performance. In still other embodiments the systems can offer time of day pricing to users for fairness and creation of incentives for hydrogen producers.

This disclosure provides a system designed and implemented as a network of consumers and producers of hydrogen to fulfill the energy needs of the community involved. While hydrogen can be transported from one site to the other by physical means such as trucking, trains, airplanes, boats, ships, and pipelines, the use of transporting energy equivalence through the electrical system is important as an option. Translocating ~33.6 kilowatt-hours (or 120 megajoules) by the electrical grid is the equivalence of translocating 1 kilogram of hydrogen by a physical means. The kilowatt-hours transmitted is the energy equivalence of moving an amount of hydrogen calculated by the formula above. Inverters and rectifiers are at each node of the plurality of hydrogen production and consumption nodes of the network to enable transporting the energy equivalence. While electricity could be used from the grid at connected sites just as easily as using transported energy equivalence, the provenance of the grid electricity cannot be guaranteed and grid electricity is generally more expensive at one site than another; if the provenance and extra cost of any grid electricity were known these could be used as accounting offsets but using grid electricity would be a useful, but less desirable embodiment.

Importing energy equivalence of zero-carbon hydrogen by the electrical grid provides for zero-carbon hydrogen availability throughout the community at the lowest cost factor. Tracking any carbon emissions directly involved in hydrogen production involves verification of specifications of the equipment, sources of electrical energy for production or movement of hydrogen, sources of fuel, and the methodology for production of hydrogen and, in certain embodiments, such tracking is important to be able to verify, validate and certify zero-carbon hydrogen. Use of renewable energy credits and virtual power purchase agreements is the method generally known to facilitate movement of electricity but the use of these is inventive for the network benefit of moving verified zero-carbon energy equivalence of hydrogen. The energy equivalence of zero-carbon hydrogen does not have to move by the electrical grid as alternatively electrical energy can be moved in the form of radiofrequency waves of various frequencies including those in the microwave range including by methods of line-of-sight transmission or satellite beaming; optical radiation; ultrasound; or the like.

In this regard, a membership implementation is useful as the provenance of the energy can be validated and certified easily; without this, the providence can still be validated and certified, but this may be more difficult, less precise and need more ongoing oversight. Also, by being a member, ideal implementations of local production equipment and methods can be provided, adjusted for scale and availability of clean sources such as solar energy. Also, a membership community provides committed producers of zero-carbon hydrogen with one of the benefits being the ability to offer stability, resiliency, and capacity to the energy infrastructure without the use of carbon sourced energy. Members can be generators and/or consumers of zero-carbon hydrogen; tracking of the generation, consumption, and storage of zero-carbon hydrogen at nodes can be accomplished; members will be provided an online account management for (a) monitoring generation and consumption of hydrogen with monthly or yearly reconciliation or per event fueling at a retail node, and (b) automation of billing activities; and members can be provided a credit card with a personal coded identifier or a similar device to enable being recognized by any public facing node (such as a retail fueling station). Carbon credits, exchangeable for legal tender, will be issued to producers of hydrogen and as a member of the network, these can more easily be aggregated for sale, and proceeds divided up. Time of day pricing for hydrogen will be for producers and users of the system. Membership will provide beneficial pricing to drive participation and overall reliable capacity of the system but non-members that create validated zero-carbon hydrogen capacity or wish to consume zero-carbon hydrogen will not be excluded.

With a network of producers and users, network tools and algorithms can be implemented for optimizing node location and capacity and placement of hubs and connectors. Scale free small networks may be optimal in some iterations to minimize lag times, minimize energy loss by transmission distance and increase scalability, but some external constructions and constraints may be desirable to adapt to the uneven distribution in any geography of supply and demand and to optimize robustness and resilience. Artificial Intelligence approaches can be used to optimize the network for robustness, scalability, and supply/demand responsiveness in an automated fashion. Techniques for matching supply and demand in connected sites is known in the art but this invention provides for matching of zero-carbon hydrogen supply and demand and in this regard is a solution to the environmental challenges being faced. Large centralized production of hydrogen from sources with carbon content, even with matching of supply and demand, will not achieve the overall requirements of this system.

Currently, methods and systems for producing hydrogen and uses of hydrogen are known in the art. However, this disclosure describes the application of the network framework and tailored methods of use at nodes in the network of various sizes. Herein, the smallest node (e.g., a home garage, parking lot or small scale fueling facility) are described integrated to the whole network and the essential elements of these nodes are described. There may be certain limitations to the small sized node (e.g., home garage, parking lot and other small-scale nodes) that are overcome with the system described. The use of low cost electrolyzers that provide for modularity and serviceability, the use of low cost pneumatic driven compressors that can be replaced in the field, and the use of cascade fueling and a priority panel to provide fueling at 350 bar quickly and up to about 700 bar, if needed, are cost optimizations. Other embodiments for fueling are by direct filling from a compressor, decanting from a buffer container or using liquid or cryocompressed hydrogen as converted to gaseous hydrogen or used onboard a vehicle. Hydrogen can be used similarly for energy use in generating electricity or heat in home applications or in larger systems such as heating or industrial processes such as steelmaking. Fueling over hours for 700 bar is optimal as this obviates the need for precooling as would otherwise be needed to adjust to the thermodynamic consequences of the Joule-Thompson effect. The minimization of the size of the high pressure buffer tank lowers the cost and is more suitable to storing only small amounts of high pressure hydrogen at residential, parking lot, and small-scale locations. Furthermore, the two largest issues limiting availability of hydrogen in retail fueling locations, freezing of the nozzle and failure of the large scale compressors, are obviated. Medium and large scale nodes are described with features including those for redundancy, modularity, scalability for growth options, and serviceability and with common and ample storage at lower pressures for backup and to provide zero-carbon hydrogen support supply to other nodes in the network.

Use of maximally efficient energy and round-trip cost effective conversion by (a) use of electrolysis technology to create hydrogen at the generating site, (b) a fuel cell of any type, linear generator, turbine, internal combustion engine, or similar device to convert hydrogen to electricity at the generating site and (c) electrolysis at the receiving site to convert electricity back into hydrogen and in such manner to transport the energy equivalence of hydrogen without physically transporting hydrogen but optimizing for round trip cost effectiveness is described. Similarly, the system could use other means of moving hydrogen in place of this or in concert with this such as by pipeline, trucking, airplane, boat, ship, rail or on the road vehicles such as cars, vans, motorcycles, scooters, and bicycles. A useful embodiment is to create hydrogen from coupling energy and heat from a nuclear reactor or fusion generator to a Solid Oxide Electrochemical Cell (SOEC) for the maximum efficiency of the overall process (see, e.g., Milewki et al., Int'l. J. of Hydrogen Energy, 46(72): 25765-35776, 2021, which is incorporated herein by reference). Less ideally, a node could be a user with less equipment needs but also less contribution to the network.

In some embodiments, a fuel cell can be used in the methods and systems of the disclosure. A reversible fuel cell system (including a system efficiently comprised of electrolysis and fuel cell stacks) such as, for example, a Solid Oxide Electrochemical Cell (SOEC) type of an at least 2 kW stack size, would be efficient for several reasons. There are a number of SOEC systems in use or development.

SOECs are the reverse counterpart of solid oxide fuel cells (SOFCs). In SOFC, hydrogen gas (H₂) is fed to an anode to combine with oxide ions (O²⁻) for hydrogen oxidation reaction, which gives off electrons (e⁻) and generates water (H₂O). Then, the electrons are transported to external circuits as electricity to the cathode. At the cathode, oxygen gas (O₂) is fed and accepts electrons from the anode to form oxide ions. These oxide ions subsequently migrate to the anode through the electrolyte to complete the circuit. Unlike SOFC, a SOEC feeds water into the cathode and the water undergoes a water reduction reaction, which converts water into hydrogen gas and oxide ions. This hydrogen gas can then be transported to purification modules to separate hydrogen gas from the remaining water. The oxide ions migrate from cathode to anode and they release electrons to an external circuit to become oxygen gas via an oxygen evolution reaction. See, e.g., Banerjee, Chem. Ing. Tech., 9495): 766-773, 2022, which is incorporated herein by reference).

SOEC systems are inherently modular, scalable and can run in electrolysis mode and fuel cell mode obviating the need for two separate devices. Also, it is the most electrically efficient in the electrolysis mode approaching 95-100% efficiency while in the fuel cell mode it approaches 80% efficiency. Such an electrochemical fuel cell can function effectively in generation of hydrogen, conversion of hydrogen to electrical energy, and generation of hydrogen at a node receiving electrical energy to facilitate the process for transporting the energy equivalence of hydrogen effectively.

The disclosure also provides methods of moving hydrogen by connecting such hydrogen fuel generation systems to pipelines (such as a natural gas pipeline at one location) wherein the provided hydrogen provides for reimbursement by the utility company or the network described herein for excess gas pumped into a gas grid such that it can be used in a distant location. The amount of hydrogen that can be inserted locally is limited by the tolerance of the pipes and appliances which currently is around a mixture of 15-20% hydrogen.

While the system is operated in a fashion as described above to produce zero-carbon hydrogen from electrolysis using various zero-carbon energy sources, it can support the possibility of buying energy directly from sources providing solar, wind, hydro, geothermal, battery-stored zero-carbon energy, nuclear fission or fusion derived energy and members will be directed to appropriate sources certified by the network. In some embodiments, the system will, depending upon cost, time of day and location, suggest a fuel/energy source that is optimal for that time of day, cost or location in order to optimize the economy in the system.

The disclosure also provides a system for distribution of zero-carbon hydrogen in gaseous or liquid state with multiple sites of production and/or use of hydrogen, the system comprising (a) transporting the hydrogen, or its energy equivalence, from one point to another, (b) an accounting system for validating transactions of producers and users of the hydrogen, (c) internet connected computing resources for tracking the provenance of the hydrogen, and various apparatuses to facilitate (a), (b) and (c) above, such as for producing, storing, transporting, and using the hydrogen or its energy equivalence. In a further embodiment of the foregoing system, real-time monitoring of a zero-carbon hydrogen energy system infrastructure is provided. Such real-time monitoring can monitor availability of infrastructure where the system functions in an automated fashion, with artificial intelligence, that is responsive to supply and demand using data including, but not limited to, storage tank capacity at each node of a plurality of nodes, hydrogen production at each node, consumer use at each node, overall hydrogen capacity of the network and the like. In another embodiment, the system further comprises a membership or networked organization of producers and users that can be individuals, commercial entities, nonprofit entities, government and military entities, tribal communities, and other groups. In still another embodiment, the system supports homes, parking lots or small scale distributed facilities, but can also take place in larger facilities of all sizes.

The disclosure also provides a system that is optimized for hydrogen production at a home, a home garage, a parking lot or other small scale nodes that are optimized for cost-effectiveness, modularity, and serviceability. In a further embodiment, the home garage, parking lot, and small scale nodes comprise: pneumatic driven compressors, electrolyzer(s) that produce 5 to 25 kg of hydrogen per week, wherein the hydrogen is stored at low pressure of 300 to 550 bar or high pressure of 600 to 950 bar, and wherein dispensing is based on pressure differentials with flow from a high storage pressure location to a lower pressure location and occurs over more than 10 minutes to less than 10 hours in a small sized node (e.g., a home node) and more than 4 hour and less than 8 hours in a parking lot. In some embodiments, precooling of hydrogen is not utilized. In still another embodiment, the electrolyzer(s), compressor(s), booster(s) and storage tanks are designed to fuel one or several hydrogen vehicles at a time.

The disclosure also provides a system that is optimized for medium-and large-scale distributed facilities of all sizes. Such large-sized nodes are designed to optimize for redundancy, modularity, scalability, serviceability, and utility to the network. In a further embodiment, a medium-and/or large-sized nodes comprise: compressor(s) including, but not limited to, diaphragm, electrochemical, or other non-contaminating compressor devices, one or more electrolyzers that produce 15 to 5000 or more kg of hydrogen per day, wherein the hydrogen is stored at low pressure of 300 to 550 bar or high pressure of 600 to 1000 bar, and dispensing is based on pressure differentials with flow from a high storage pressure to the lower pressure and occurs over more than 3 minutes but less than 1 hour. In some embodiments, precooling of hydrogen is utilized for fueling at higher pressures, and the electrolyzer(s), compressor(s) or and storage tank(s) are designed to fuel several vehicles at a time but can fuel one vehicle at a time. In still further embodiments, the systems includes converting hydrogen to electrical energy by use of a fuel cell or generator (see, e.g., Hitachi Energy, HyFlex™), or Proton Exchange Membrane type, Anion Exchange Membrane type, Solid Oxide type, Alkaline Exchange Membrane type or other types, or by use of a linear generator, turbine, internal combustion engine, or similar device. In still another embodiment, the systems include maximizing efficient energy conversion and round-trip cost-effectiveness by use of reversible Solid Oxide Electrochemical Cell technology having a stack size of a minimum of 2 kW or more to create hydrogen, to convert hydrogen to electricity at the generating site and to receive electricity from the generating site of hydrogen and convert this back into hydrogen to transport the energy equivalence of hydrogen. In still another embodiment, the system includes use of renewable energy credits to facilitate a virtual power purchase exchange to move electricity between producers of hydrogen who convert hydrogen to electricity and those who will receive the energy equivalence of hydrogen. In still another or further embodiment, the system provides for transporting hydrogen in a gas or liquid pipeline, designed for hydrogen or otherwise deemed appropriate for hydrogen, between two locations. In still another embodiment, the system transports hydrogen from one source to another by use of a truck, car, van, boat, ship, or train or other similar transportation method, where the hydrogen is stored in a vessel suitable for transportation.

The disclosure also provides a system of distribution of hydrogen, which consists of one or more private hydrogen producer(s) (i.e., that are not an operator of a utility entity) delivering hydrogen into either (i) a hydrogen gas line or (ii) a natural gas line for blending with natural gas to allow offtake in separate locations of the commercial line with the utility or natural gas line operator facilitating such movement of hydrogen and the zero-carbon hydrogen network system accounting for the amount of hydrogen gas inserted or removed by the parties involved. In another embodiment, the system provides for the issuance of carbon credits to a producer of hydrogen wherein such carbon credits may be exchangeable for legal tender and production of hydrogen by different members can be aggregated and the proceeds divided up proportionally from sale outside the network.

The disclosure also provides a system for distribution of zero-carbon hydrogen in gaseous or liquid state with multiple sites of production and/or use of hydrogen consisting of a network of nodes and hubs to minimize lag times or loss of energy due to long distance transmission of energy and to increase scalability.

In still other embodiments of any of the foregoing embodiments, the systems include the ability, in addition to or in place of using hydrogen electrolysis, of buying energy directly from sources such as solar, wind, hydro, geothermal energy, battery, or nuclear or fission energy wherein members are directed to sources certifying a zero-carbon footprint.

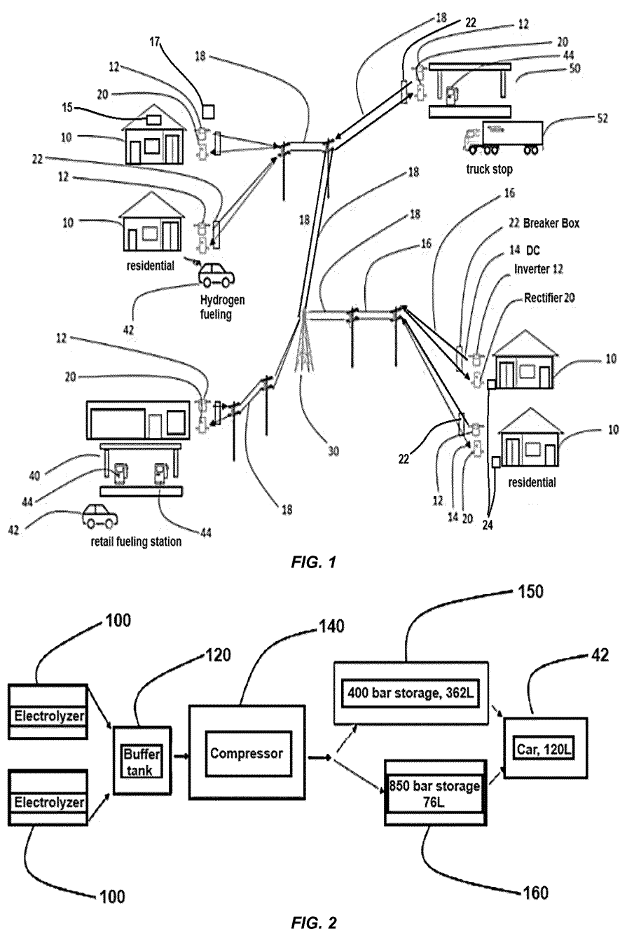

FIG. 1 is an embodiment of a network 5 showing the movement of the energy equivalence of zero-carbon hydrogen over an electrical grid 18 to and from home nodes 10, a medium-scale retail fueling station node 40 (such as a retail parking garage) and a large-scale refueling station node 50 (such as that used for trucks). In the section of the illustration marked residential, energy can be supplied by solar panels 15 on the site to feed electrolyzer(s) 17 in the home node 10. The various nodes include compressors, storage, a priority panel, and a dispensing apparatus, as illustrated below in FIGS. 2, 3, 4 and 5. Also, each node (10, 40, 50) includes an inverter 12 for converting the DC electricity 14 into AC electricity 16 for transport over the electrical grid 18 and an electrical energy meter 24 to quantitate the amount of energy in kWh or MJ (for reference, 1 kilowatt-hour=3.6 Megajoules) delivered through, into or from the network 5. The nodes (10, 40, 50) can also have a rectifier 20 for delivering the hydrogen equivalence from the AC electricity of the network to the DC electricity 14 of a node. The connection from a node (e.g., 10, 40 and/or 50) to the electrical grid 18 takes place via a breaker box 22.

If hydrogen were to be moved by, for example a pipeline or truck, a mass flow meter may be used to measure the hydrogen transported. If the equipment at a particular node is owned by the owner of the property at said node, then other equipment such as a mass flow meter, owned by the network, may be used to measure the hydrogen produced at such a node. At all nodes, instrumentation to be responsive to network needs can be installed including equipment needed to measure hydrogen volume and pressure in storage and available for the network use. Since a node is registered on the network in one embodiment, the provenance of the hydrogen is known, verified, validated, and certified ensuring only zero-carbon energy equivalence is being conveyed. All data gathered on transmission of energy equivalence or hydrogen is tracked by an accounting system and available through an online cloud and/or mobile application.

When instruments determine stored hydrogen decreases beyond a certain level an energy demand state is set at a node. Depending on the local availability of zero-carbon hydrogen or energy equivalence and communications or instructions received contemporaneously or in advance or by artificial intelligence and taking into account cost differentials of energy availability, demand is relayed to the network and zero-carbon hydrogen is then delivered by zero-carbon energy equivalence or otherwise to the node in such a demand state. If such a demand is satisfied by delivery of energy equivalence, such energy equivalence will be converted to hydrogen by an electrolyzer. If such a demand is satisfied by delivery of hydrogen gas, it can be used directly (in some instances this may require compression or heating or cooling). If hydrogen comes in the form of liquid, it may need pumping and vaporization. When instruments determine stored hydrogen increases beyond a certain level, supply availability is relayed to the network and can be delivered on demand by a node in a supply state. With no overrides or interventions, the electrolyzers and compressors and/or liquefiers will respond to the stored hydrogen determination by activating at their low hydrogen set point and deactivating at their higher set point, providing an appropriate degree of local feedback control. One method to quantitate hydrogen amount in a node is by recording the hydrogen volume of a hydrogen storage tank and pressure in storage tanks.

FIG. 1 shows a multitude of home nodes 10, either near each other or separated by significant distance (as indicated by transmission over a high voltage transmission tower 30). The illustration also shows a medium-scale retail fueling station node 40 for fueling a car 42 via a dispenser 44 and a large-scale heavy duty vehicle fueling station node 50 for fueling a truck 52 via a dispenser 44. Parking lot and other non-residential small-scale nodes are not depicted, but can be part of this network. Moreover, large-scale nodes 50 are not limited to heavy duty vehicle fueling stations, but can include industrial hydrogen usage facilities such as in steelmaking, sites of power generation or electric vehicle charging, or industrial, retail, or home facilities, as the case may be, for fueling buses, boats, ships, submarines, trains, forklifts, motorcycles, bicycles, grills, home heaters, water heaters, military ordinances, or airplanes or for providing power to various devices or systems.

FIG. 2 shows an embodiment of the flow of hydrogen at a home, a parking lot, or small-scale fueling facility (e.g., a retail or home facility; e.g., 10 or 40 in FIG. 1). An electrolyzer(s) 100 are small in scale, modular and redundant, there is a buffer tank 120 to accumulate hydrogen and match hydrogen flow from the electrolyzers to compressor(s) 140. The electrolyzer(s) 100, in one embodiment, each generate 250 to 750 NL per hour of zero-carbon hydrogen which equates to about 1-2 kg hydrogen per 24 hours and are stacked to be redundant and deliver from 5 kg to 25 kg per week of hydrogen. At this scale, compressor(s) 140 are useful. Storage is primarily at 25-50 bar, 50-100 bar, 100-200 bar, 200-300 bar, or 300-550 bar (or any value between any of the foregoing) for safety and regulatory purposes. A cascade fueling protocol will first use low pressure hydrogen 150 to fill the tank of a car 42 to equilibrium and then high pressure hydrogen 160 to top off the vehicle tank. Higher pressure hydrogen, at 600-950 bar, will be stored in the amount left over from prior uses and is also generated on demand. Hydrogen can flow rapidly at low pressure as this is safe. In one embodiment, precooling is not utilized and fueling at high pressure will therefore need to occur slowly, largely matching hydrogen generation. Fueling can occur over a time period of 10 minutes to 10 hours. Without precooling, the negative Joule-Thompson coefficient of hydrogen, which causes heat generation on fueling, precludes rapid fueling with high pressure hydrogen. In this embodiment, a 362 L 400 bar storage vessel 150 and a 76 L 850 bar storage vessel 160 are illustrated as these devices are readily available, but other combinations of pressure and volume can be used with one embodiment being close to a 4-5 to 1 volumetric ratio of low to high pressure hydrogen in the storage tanks. Water will be adjusted for conductivity above the rating of the electrolyzers, which in one embodiment is 5 microsiemens/cm.

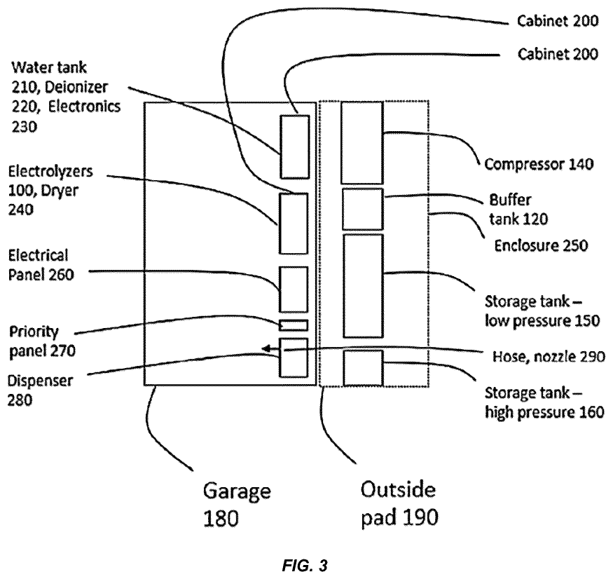

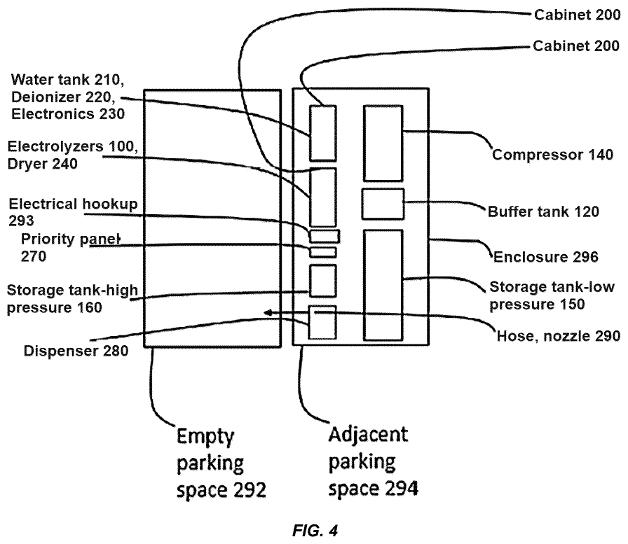

FIG. 3 shows an embodiment of a home node (e.g., 10 in FIG. 1) implementation with a garage space 180 and the outside cement pad 190. The electrolyzer(s) 100 can be located in a cabinet 200. The water tank 210, deionizer 220, electronics panel 230, and dryer 240 can also, optionally, be placed inside the same or a different cabinet 200. The buffer tank 120, and air compressor 140 are optionally located on outside pad 190 for space considerations and the hydrogen storage tanks for low pressure 150 and high pressure 160 are typically located on the outside pad 190 for maximizing distance from a dwelling for safety concerns. The outside components can optionally be in enclosure 250. Connection to power will be through the electrical power panel 260; in some embodiments power is provided by a solar array (not shown). A priority panel 270 will facilitate the cascade fueling (fueling from low pressure first and then high pressure hydrogen) and connects the low pressure 150 and high pressure 160 storage tanks to the dispenser 280, which then connects to the hose and nozzle assembly 290 for car fueling.

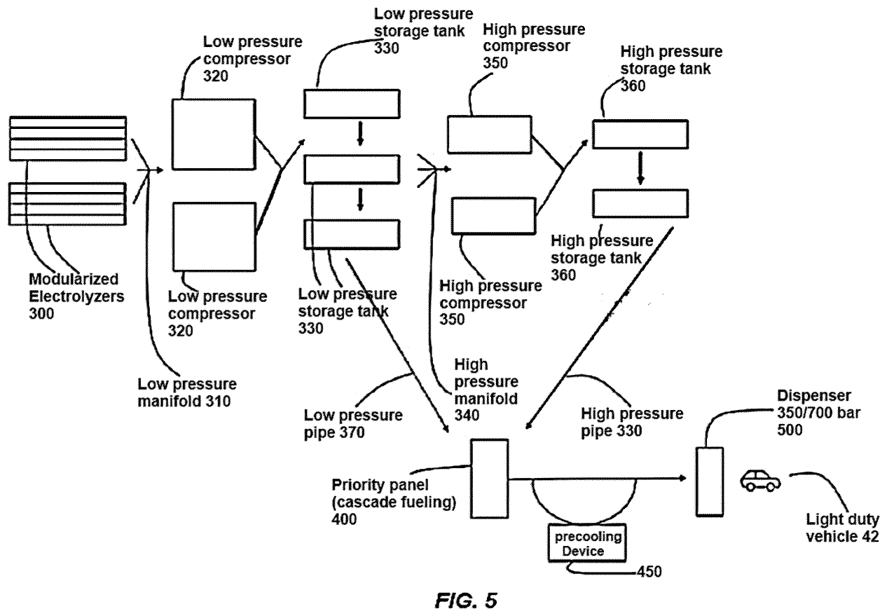

FIG. 4 shows the embodiment of a parking lot node (e.g., 40 in FIG. 1) with an empty parking space 292 for a car or other vehicle and an adjacent space 294 for the equipment needed for refueling. Space optimization is not as critical here as compared to a residential garage (e.g., FIG. 3). To protect the equipment from environmental extremes, the equipment is located in an enclosure 296 of a size appropriate for the node. Power will be from a central source connected to a power hookup panel 298 with zero-carbon energy, e.g., from a solar panel array. In one embodiment, such as for a workplace, fueling would occur from 4 to 8 hours. A deionizer 220 lowers the conductivity of water, a water tank 210 collects and stores water after deionization by deionizer 220. An electronics panel 230 distributes electricity and the electrolyzer(s) 100 are typically modular and small in scale, each generating 250 to 750 NM³ of hydrogen per hour. Effluent from the electrolyzer(s) 100 enters a dryer 240 to remove excess water, then a buffer tank 120 which feeds into a compressor 140. The compressor output flows to low 150 and high-pressure 160 storage tanks preferentially filling the low-pressure storage tank 150 prior to the high-pressure tank 160. For fueling, a vehicle enters an empty parking space 292 and the nozzle and hose 290 are connected to the car with hydrogen flowing from the dispenser 280, with filling from the low-pressure storage tank 150 and then the high-pressure storage tank 160 as directed by the priority panel 270. A small-scale node (e.g., 10 in FIG. 1) is similar to this parking lot node 40, but may not be in a parking lot per se and may only need to deliver low pressure hydrogen such as in forklift fueling.

FIG. 5 shows an embodiment of a medium to large scale fueling station (e.g., 50 in FIG. 1), including, but not limited to, light, medium and heavy-duty vehicle fueling stations. Modularized electrolyzer(s) 300, comprising electrolyzer cells, stacks and balance, will be used with redundant compressor 320, 350 and storage equipment 330, 360, a key to uptime and supplying the zero-carbon hydrogen network. Medium-scale and large-scale nodes will produce more hydrogen. Failure at a smaller node will have less effect on the network but failure of a medium or larger node will have more impact and therefore redundancy is more desirable. Stack size is 2.5 to 1000 kw. A low-pressure manifold 310 of piping will direct the effluent of hydrogen from the electrolyzers 300 to redundant low pressure compressors 320 with the output of the compressors stored sequentially in a series of low pressure storage tanks 330. Low-pressure hydrogen is then directed through a high-pressure manifold 340 to a separate set of higher-pressure compressors 350 for generating higher pressure hydrogen and the higher pressure hydrogen is stored sequentially in a series of higher pressure storage tanks 360. A cascade fueling approach will fuel with low pressure storage first through a low-pressure pipe 370 and then higher pressure hydrogen through a high pressure pipe 380 directing flow to a priority panel 400. To fuel faster, the priority pane 400 will direct flow to a precooling device 450 to meet faster fueling requirements of commercial entities that require high pressure hydrogen. The gas will be directed to a dispenser 500 to fuel a vehicle, in this case a light duty vehicle 42. Generally, hydrogen bicycles, scooters, and buses require only low pressure fueling, simplifying the implementation and costs but motorcycles, boats, forklifts, and trucks may use either 350 or 750 bar hydrogen depending on the manufacturer, size of the vehicle, and desired use. Light duty passenger vehicles require high pressure hydrogen. Proper use of a priority panel 400 can ensure some hydrogen is available at one pressure or another, if needed, and will manage a multitude of low or high pressure storage vessels. The system may further include a buffer tank, control panels, gas detectors, relief values, pressure reducing and needle valves, and a water deionizer or reverse osmosis system as desired.

Although this disclosure has described and illustrated certain preferred embodiments of the invention, it is to be understood that the invention is not to be limited to these particular embodiments. To the contrary, the invention includes all embodiments which are functional, mechanical, or otherwise equivalents of the embodiments and features that have been described and illustrated. For example, where hydrogen refueling is described, fueling by use of liquid hydrogen or cryocompressed hydrogen gas is to be considered other embodiments of the Inventions. Also, use in fuel cell applications such as providing power to buildings for heating, cooling and lighting are other embodiments.

Other embodiments, combinations and modifications of this invention will occur readily to those of ordinary skill in the art in view of these teachings.

Therefore, this invention is to be limited only by the following claims, which include all such embodiments and modifications when viewed in conjunction with the above specification and accompanying drawings.

1. A system for managing zero-carbon energy production and distribution, wherein the system comprises:
a zero-carbon hydrogen power grid and an optional electrical power grid;
a control server or server subsystem;
a plurality of energy consumption and production nodes;
one or more hydrogen production systems associated with each node or a subset of nodes;
one or more hydrogen storage tanks associated with each node or a subset of nodes;
optionally one or more solar collection systems associated with each node or a subset of nodes;
optionally one or more electrical storage batteries associated with each node or a subset of nodes;
at least one metering system at each node;
wherein the control server or server subsystem:
receives information about energy data at each of the plurality of nodes, wherein information about energy data is selected from hydrogen levels, tank pressure, battery charge, electrolyzer production criteria, energy consumption data, solar panel array production and any combination thereof;
performs a load balancing evaluation based on the received information about energy and hydrogen data,
generating node energy information comprising energy excess and energy insufficiency based on results of the load balancing evaluation,
sending the generated node energy information to the at least one metering system; and
adjusting distribution of hydrogen and/or optional energy equivalence from a high energy node to a low energy node.

2. The system of claim 1, further comprising providing an energy credit to the high energy node from which energy was distributed to the low energy node by recording the transaction in a real-time accounting system that also records the provenance of the hydrogen produced.

3. The system of claim 1, wherein performing the load balancing evaluation includes updating a database comprising energy usage at each node over time to identify peak energy consumption time or energy production time for each node.

4. The system of claim 1, wherein the adjusting distribution of hydrogen and/or energy equivalence comprises (i) pumping or moving hydrogen from a node of high hydrogen content to a node of low hydrogen content; or (ii) transmission of electrical energy from a node of high energy content to a node of low energy content wherein the transmission of about 33.6 kWh of electricity is the energy equivalence of transmitting 1 kg of Hydrogen or 120 Megajoules of energy.

5. (canceled)

6. The system of claim 4, wherein a node converts the electrical energy to hydrogen.

7. The system of claim 1, wherein excess hydrogen is stored in one or more hydrogen storage tanks in a gaseous, liquid, or cryocompressed state or absorbed to a liquid organic hydrogen carrier or into a metal hydride or various absorbent substances or subterranean caverns or other geologic formations or the process of generating a hydrogenated chemical substance such as methanol, ammonia or other hydrogen containing molecular entity.

8. The system of claim 7, wherein excess hydrogen is converted to electrical energy and the electrical energy stored in electrical storage batteries.

9. The system of claim 8, wherein the electrical energy is converted to hydrogen and the hydrogen stored in hydrogen storage tanks.

10. (canceled)

11. The system of claim 1, which further comprises real-time availability of energy distribution infrastructure wherein the system functions in an automated fashion, with artificial intelligence, that is responsive to supply and demand using generated and/or stored data.

12. The system of claim 1, wherein each node comprises:
(a) one or more compressor(s) or liquefiers,
(b) at least one electrolyzer that produces 5 to 25 kg of hydrogen per week.

13. The system of claim 1, wherein hydrogen is stored at low pressure of 300 to 550 bar or high pressure of 600 to 950 bar or as subcooled low pressure liquid hydrogen or as supercritical hydrogen at 350 to 500 bar.

14. The system of claim 1, wherein hydrogen gas distribution is based on pressure differentials with flow from a hydrogen storage tank comprising high pressure to a lower pressure hydrogen storage tank.

15-17. (canceled)

18. The system of claim 1, wherein the plurality of energy consumption and production nodes are selected from the group consisting of a residential home, a retail refueling station and a large scale energy production facility.

19-20. (canceled)

21. The system of claim 18, wherein the plurality of energy consumption and production nodes comprise a zero-carbon hydrogen production unit, wherein the zero-carbon hydrogen production unit comprises
at least one electrolyzer that produces 5-2000 or more kg of hydrogen per week;
at least one buffer tank;
at least one compressor or liquefier; and
at least one hydrogen storage tank;
wherein the at least one electrolyzer is fluidly connected to the at least one buffer tank, which accumulates zero-carbon hydrogen, wherein the at least one buffer tank is fluidly connected to the at least one compressor and/or liquefier, wherein the compressor and/or liquefier is fluidly connected to the at least one hydrogen storage tank and pumps zero-carbon hydrogen into the at least one storage tank to a desired pressure and temperature.

22. The system of claim 21, wherein the at least one compressor is a pneumatic type, a diaphragm, screw or an electrochemical type of compressor.

23. (canceled)

24. The system of claim 21, wherein the zero-carbon hydrogen is stored at 1-25 bar, 25-50 bar, 50-100 bar, 100-200 bar, 200-300 bar, 350-550 bar and/or 600-1000 bar.

25. (canceled)

26. The system of claim 21, wherein dispensing zero-carbon hydrogen to a vehicle is based on pressure differentials with flow from the at least one hydrogen storage tank or compressor to a lower pressure and occurs over more than 10 minutes to less than 10 hours.

27. The system of claim 24, wherein precooling of hydrogen is not utilized, and the at least one electrolyzer, at least one compressor and at least one hydrogen storage tank can fuel one or several vehicles at a time.

28. The system of claim 26, wherein a cascade fueling protocol will first use low pressure hydrogen to fill a vehicle to equilibrium and then high-pressure hydrogen to top off the vehicle.

29. The system of claim 21, wherein the at least one hydrogen storage tank is fluidly connected to the zero-carbon hydrogen power grid.

30-34. (canceled)

35. The system of claim 21, wherein precooling of zero-carbon hydrogen is utilized.

36-37. (canceled)

38. The system of claim 1, wherein the provenance of zero-carbon hydrogen can be attributed to an energy production source.

39-42. (canceled)

43. The system of claim 1, which further comprises maximizing efficient energy conversion and round-trip cost-effectiveness by use of Solid Oxide Electrochemical Cell technology having a stack size of a minimum of 2 kW to generate hydrogen, to convert hydrogen to electricity at the generating site and to receive electricity from the generating site of hydrogen and convert this back into hydrogen and in such manner to transport the energy equivalence of hydrogen.

44. The system of claim 1, comprising transporting hydrogen in a gas or liquid pipeline, designed for hydrogen or otherwise deemed appropriate for hydrogen, between two locations.

45. The system of claim 1, comprising transporting hydrogen from one location to another location using a truck, car, van, motorcycle, scooter, bicycle, airplane, boat, ship, train or other vehicle, wherein the hydrogen is stored in a device suitable for transportation of a gas.

46. The system of claim 1, further comprising applying network optimization and artificial intelligence methods, techniques and algorithms or the like, to improve the ability of the network or membership to deliver robust, scalable, and reactive performance.

47. A system of distribution of hydrogen, comprising a hydrogen producer(s) that is not an operator of a utility entity, the hydrogen producer delivering hydrogen into a natural gas line for blending with natural gas to allow offtake at a separate location fluidly connected to the natural gas line, wherein a utility or natural gas line operator facilitates virtual movement of hydrogen and accounting for the amount of hydrogen gas delivered or removed by the hydrogen producer(s) or a consumer.

48. The system of claim 47, wherein the distribution of hydrogen is for any industrial, commercial or residential use selected from the group consisting of fuel for transportation, heating and cooling, grills, fuel for electricity generation for various uses, and applications in steelmaking, food processing and semiconductor manufacture.

49. A system of claim 1, wherein hydrogen is created with use of solar, wind, hydro, geothermal energy, zero-carbon battery storage, or nuclear, fusion or fission energy.

50. A system of claim 49, wherein hydrogen is created from coupling energy and heat from a nuclear reactor or fusion generator to a Solid Oxide Electrochemical Cell electrolyzer for the maximum efficiency of the overall system.
